(19) United States
(12) Patent Application Publication
(10) Pub. No.: US 2005/0159162 A1
(43) Pub. Date: Jul. 21, 2005

(54) Method for transmitting data in mobile communication network

(75) Inventor: Yun-Sang Park, Yeongtong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/978,780

(22) Filed: Nov. 1, 2004

(30) Foreign Application Priority Data
Jan. 20, 2004 (KR) 4181/2004
Feb. 16, 2004 (KR) 10177/2004

(51) Int. Cl. H04Q 7/20

(52) U.S. Cl. 455/450

(57) ABSTRACT

Disclosed are a mobile terminal and mobile communication system capable of changing downlink traffic and a method for transmitting data in a mobile communication network using the same. When at least one predetermined requirement for an additional downlink traffic allocation request is met, the additional downlink traffic allocation request is sent from a mobile terminal (MT) to a base station (BS). The BS, receiving the additional downlink traffic allocation request, determines whether or not additional downlink traffic allocation is possible. If the additional downlink traffic allocation is determined to be possible, the BS allocates the additional downlink traffic to the MT and transmits a downlink signal using downlink traffic including the additionally allocated downlink traffic.

### PRIORITY

This application claims priority to two applications entitled “Mobile Terminal and Mobile Communication System Capable of Changing Downlink Traffic and Method for Transmitting Data in Mobile Communication Network Using the Same”, filed in the Korean Intellectual Property Office on Jan. 20, 2004 and assigned Serial No. 2004-4181 and filed on Feb. 16, 2004 and assigned Serial No. 2004-10177, the contents of each of which are incorporated herein by reference.

### BACKGROUND OF THE INVENTION

1. Field of the Invention

The present invention relates to a mobile terminal and mobile communication system capable of changing downlink traffic and a method for transmitting data in a mobile communication network using the same, and more particularly to a method for transmitting data in a mobile communication network that can enhance service quality by taking into account transmission quality according to a distance between a base station (BS) and a mobile terminal (MT).

2. Description of the Related Art

Conventionally, mobile terminals (MTs) are located around a base station (BS) and the MTs transmit uplink-based data via the BS and receive downlink-based data from the BS in a wireless fashion, in a mobile communication network. In this manner the mobile communication network can provide service only to the MTs located within a predetermined distance according to the characteristics of the wireless transmission. This is because signal attenuation occurs in proportion to the distance between the BS and an MT. In the mobile communication network, BSs are located at predetermined distance intervals. According to the movement of a user, the MT performs mobile communication while changing its access point from one BS to another BS. The process for changing the access point is called a handoff, and is carried out during a call lifetime.

FIG. 1 shows the configuration of a conventional mobile communication network. Referring to FIG. 1, a base station (BS) 10 manages various types of communication-related information of the mobile terminals (MTs) 21 and 23 located within a predetermined area “A” capable of receiving a signal from the BS 10, and controls communication services. In this case, the area “A” covered by the BS 10 is called a cell. A mobile communication system that divides a large area for the mobile communication service into a plurality of cells and that supports the mobile communication service is referred to as a “cellular mobile communication system”. Because the cellular mobile communication system constitutes the plurality of cells in a given geographic area as one system, attenuation due to a signal from a neighboring cell may be incurred in addition to signal attenuation in a wireless zone between the BS and the MT. Because of this signal attenuation phenomenon, a sharp signal attenuation typically occurs at a cell edge. When this occurs the MT and the BS take into account signal attenuation information or the MT's movement direction to perform a handoff.

Conventionally, a transmission rate of a data system link is determined by performance of the link. The increased signal attenuation due to a spaced distance in the mobile communication network causes a corresponding link's performance to be degraded. Thus, if the MT is located close to the BS, the transmission rate is fast. On the other hand, if the MT is located far from the BS, the transmission rate is slow.

In an example shown in FIG. 1, the first MT 21 is spaced from the BS 10 by a first distance d₁, and the second MT 23 is spaced from the BS 10 by a second distance d₂. Transmission quality of the first MT 21 is better than that of the second MT 23 since d₁<d₂. That is, a transmission rate of the first MT 21 is greater than that of the second MT 23.

FIG. 2 shows a graph illustrating the relationship between a data transmission rate “V” and a distance “d” between a BS and an MT in a mobile communication network. In FIG. 2, it is assumed that a transmission rate that must be ensured in order for the MT to perform data communication normally is “V_{MT}”. In this case, when the distance “d” between the BS and the MT is “0”, the data transmission rate “V” of the MT is greatest. Subsequently, when the distance “d” between the BS and the MT is “d_{MT}”, the data transmission rate “V” of the MT is “V_{MT}”. As the distance “d” between the BS and the MT is greater than “d_{MT}”, the data transmission rate “V” of the MT is reduced below “V_{MT}”.

For on-demand services such as Video On Demand (VOD), Music On Demand (MOD), etc., that provide predetermined video and music according to a user request, a data transmission rate change between the BS and the MT causes service quality to be different according to the location of the MT. For example, a zone in which extreme signal attenuation occurs, that is, a zone in which a distance between the BS and the MT is greater than “d_{MT}” as shown in FIG. 2, typically does not meet a minimum transmission rate for the on-demand service. On the other hand, a zone in which the BS is located close to the MT, that is, a zone in which a distance between the BS and the MT is less than “d_{MT}” as shown in FIG. 2, a transmission rate required for the on-demand service is relatively faster. In this case, the BS can transmit data to the MT at greater than an allowed transmission rate (e.g., rate of data transmission in bits per unit time). Nevertheless, because the BS transmits data according to only a preset transmission rate value, it does not transmit data at a rate greater than the preset transmission rate.

Consequently, there is a problem in that resources available for data communication cannot be appropriately utilized. That is, there is a problem in that data cannot be efficiently transmitted.

### SUMMARY OF THE INVENTION

Therefore, the present invention has been made in view of at least the above problems, and it is a first object of the present invention to provide a mobile terminal and mobile communication system and a method for transmitting data using the same that can enhance data transmission efficiency in a mobile communication network.

It is a second object of the present invention to provide a mobile terminal and a mobile communication system and a method for transmitting data using the same that can maximally utilize remaining available resources when data is transmitted between a base station (BS) and a mobile terminal (MT).

It is a third object of the present invention to provide a mobile terminal and a mobile communication system and a method for transmitting data using the same that can stably provide on-demand services in a mobile communication network.

In accordance with one embodiment of the present invention, the above and other objects can be accomplished by the provision of a method for transmitting data in a mobile communication network, which includes, sending the additional downlink traffic allocation request from a mobile terminal (MT) to a base station (BS) when at least one predetermined requirement for an additional downlink traffic allocation request is met; determining, by the BS receiving the additional downlink traffic allocation request, if additional downlink traffic allocation is possible; and if the additional downlink traffic allocation is determined to be possible, allocating additional downlink traffic to the MT and transmitting a downlink signal using downlink traffic including the additionally allocated downlink traffic from the BS.

In accordance with another embodiment of the present invention, the above and other objects can be accomplished by the provision of a mobile terminal, including a controller for performing a control operation so that an additional downlink traffic allocation request can be transmitted to a base station (BS) when at least one requirement for the additional downlink traffic allocation request is met; a transmitter for transmitting the additional downlink traffic allocation request to the BS under control of the controller; and a receiver for receiving a downlink signal from the BS using a downlink traffic including additionally allocated downlink traffic in response to the request.

In accordance with yet another embodiment of the present invention, the above and other objects can be accomplished by the provision of a mobile communication system, including a mobile terminal (MT) for sending an additional downlink traffic allocation request to a base station (BS) when at least one predetermined requirement for the additional downlink traffic allocation request is met; and a BS responsive to the request for allocating additional downlink traffic and transmitting a downlink signal using downlink traffic including the additionally allocated downlink traffic if additional downlink traffic allocation is determined to be possible.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows the configuration of a conventional mobile communication network;

FIG. 2 shows a graph illustrating the relationship between a data transmission rate and a distance between a base station (BS) and a mobile terminal (MT) in a mobile communication network;

FIG. 3 is a flow chart illustrating a method for transmitting data in the mobile communication network in accordance with one embodiment of the present invention;

FIG. 4 illustrates the format of an uplink data frame necessary for transmitting quality information of a downlink signal from the MT to the BS in the mobile communication network;

FIG. 5 shows the format of a typical data frame in a broadband wireless access communication system based on Orthogonal Frequency-Division Multiple-Access (OFDMA) technology;

FIG. 6 illustrates a concept of allocating a downlink interval usage code (DIUC) to a user interval by interval in a downlink map (DL MAP) of the typical data frame in the broadband wireless access communication system;

FIG. 7 shows the example of a data frame necessary for transmitting a result of a downlink traffic change from the BS to the MT in accordance with one embodiment of the present invention;

FIG. 8 shows an example of storing downlink data in a memory provided in the MT receiving added downlink traffic data in accordance with one embodiment of the present invention; and

FIG. 9 is a block diagram illustrating a configuration of the MT in accordance with one embodiment of the present invention.

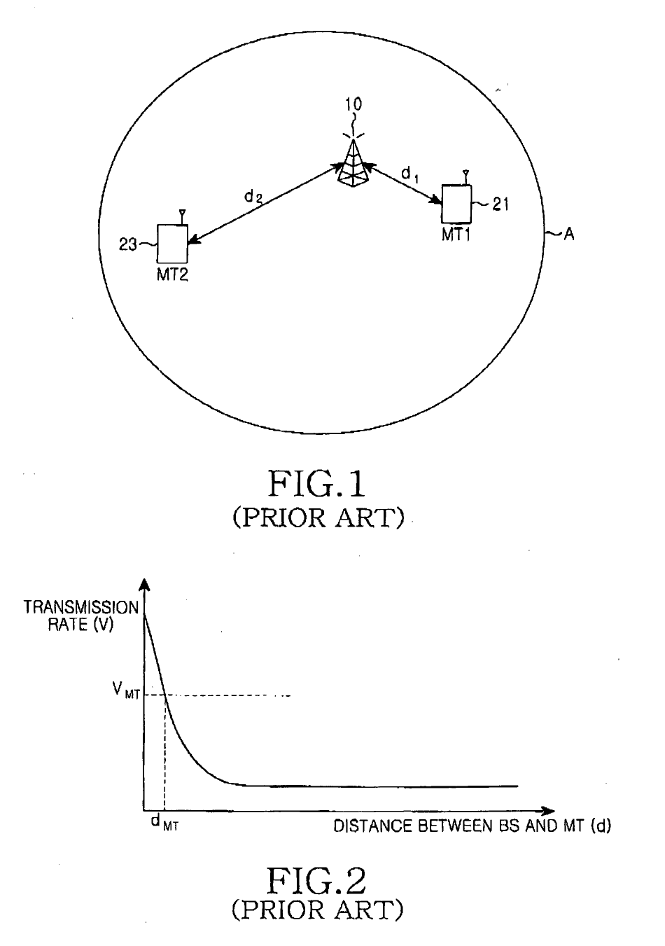

### DETAILED DESCRIPTION OF THE PREFERRED EMBODIMENT

Now, preferred embodiments of the present invention will be described in detail with reference to the annexed drawings. In the following description, a detailed description of known functions and configurations incorporated herein will be omitted when it may obscure the subject matter of the present invention.

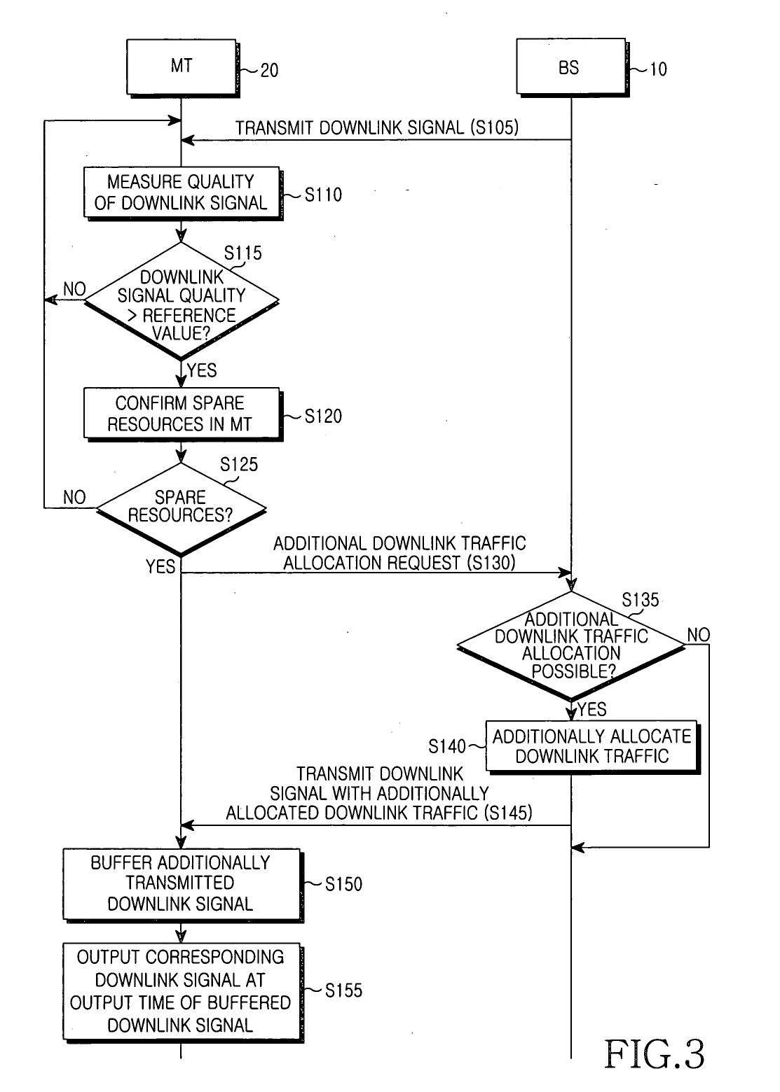

FIG. 3 is a flow chart illustrating a method for transmitting data in the mobile communication network in accordance with one embodiment of the present invention. In more detail, FIG. 3 shows a process for transmitting data between a base station (BS) 10 and a mobile terminal (MT) 20 in accordance with one embodiment of the present invention. In this case, the BS 10 serves as a typical data access point, and is responsible for allocating radio resources for exchanging data with the MT 20. Moreover, the BS 10 may be able to be notified of a degree of attenuation of a signal from the MT 20. The MT 20 serves as an entity consuming radio resources allocated from the BS 10. Moreover, the MT 20 may be able to measure the quality of a signal received from the BS 10 and support a required transmission rate according to at least of the degree of use of a memory provided therein, an on-demand service type, or combinations thereof. In the more desirable embodiment of the present invention, to use the on-demand service, the MT 20 may be able to instantaneously measure the radio resources (e.g., transmission rate, etc.) allocated thereto and the quality of a signal received from the BS 10, and may be able to compare the measurement results.

FIG. 3 is a flow chart illustrating a method for transmitting data in the mobile communication network in accordance with one embodiment of the present invention.

First, the BS 10 transmits a downlink signal to the MT 20 (S105), and the MT 20 measures the quality of the downlink signal (S110). At this point, measurement values necessary for determining the downlink signal quality are values typically used in the communication system, for example, a Signal to Noise Ratio (SNR), Carrier to Interference Ratio (CIR), a Signal to Interference and Noise Ratio (SINR), the average number of Cyclic Redundancy Checking (CRC) errors, etc. In particular, a moving average value between the measurement values is used in order for the quality of a downlink signal to be measured. This is to filter an error of a measurement value due to an instantaneous state change of a channel (e.g., fast fading, etc.).

As described above, the MT 20 measuring the quality of a downlink signal compares a measurement value with a preset reference value (S115). The measured downlink signal quality is compared with a preset reference value necessary for ensuring a normal data transmission in an application (e.g., on-demand service) currently run in the MT 20.

If the downlink signal quality is equal to or greater than the reference value, the MT 20 confirms available resources therein (S120). When available resources are determined to be present (S125), the MT 20 sends an additional downlink traffic allocation request to the BS 10 (S130). For example, the MT 20 confirms a state of the memory provided therein, a central processing unit (CPU) occupancy state, etc. and determines whether or not its own terminal can accommodate additional downlink traffic. If the MT 20 can accommodate the additional downlink traffic according to a result of the determination, the MT 20 sends the additional downlink traffic allocation request to the BS 10.

The present invention is not limited to the embodiment shown in FIG. 3. Steps S110, S115, S120 and S125 are interchangeable. That is, when the quality of a downlink signal received by the MT 20 is greater than a preset reference value in FIG. 3, the MT 20 determines whether or not available resources are present inside the MT 20 and then makes an additional downlink traffic allocation request. Alternatively, the MT 20 can first determine whether or not available resources are present therein, confirm the quality of a downlink signal if available resources are present, and make the additional downlink traffic allocation request.

At the above step S130, a method for sending the additional downlink traffic allocation request from the MT 20 to the BS 10 can be variously implemented.

For example, an uplink data frame contains a field set for transmitting quality information of a downlink signal from the MT 20 to the BS 10 in the case of the broadband wireless access communication system. In a communication system in which the quality information field is set in the uplink data frame, such as the broadband wireless access communication system, it is preferred that the MT 20 sends the additional downlink traffic allocation request to the BS 10 using the signal quality information field.

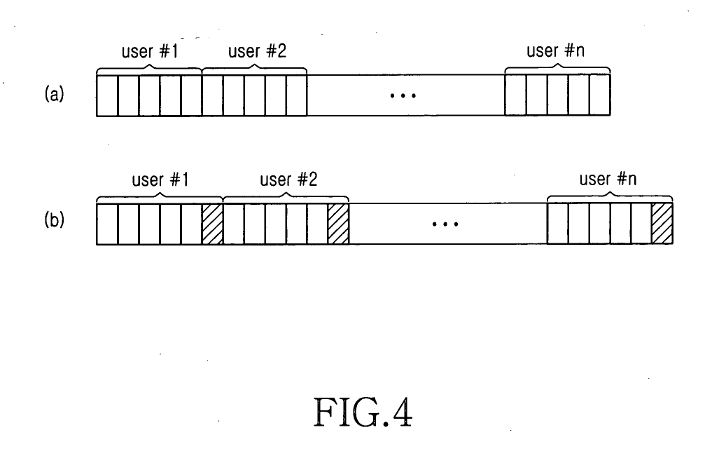

FIG. 4 exemplarily shows the format of an uplink data frame necessary for transmitting the quality information of a downlink signal from the MT to the BS in the mobile communication network. FIG. 4(a) shows an example in which a 5-bit field is allocated to each MT in order for the MT to transmit the quality information of a downlink signal to the BS. FIG. 4(b) shows an example in which a 1-bit field indicating an additional downlink traffic allocation request is added to the uplink data frame containing the typical 5-bit field shown in FIG. 4(a). As shown in FIG. 4(a), the field indicating the additional downlink traffic allocation request is hatched.

Again returning to FIG. 3, in step S130 the MT 20 includes an additional downlink traffic allocation request signal in the additional downlink traffic allocation request field of the uplink data frame allocated to its own terminal and then transmits the additional downlink traffic request signal, when employing the uplink data frame shown in FIG. 4(b) to send the additional downlink traffic allocation request to the BS 10. For example, the MT 20 sets a bit value of the additional downlink traffic allocation request field allocated to its own terminal to “1”, and transmits the bit value of the additional downlink traffic allocation request field to the BS 10. If no additional downlink traffic allocation request is made, the MT 20 sets a bit value of the additional downlink traffic allocation request field allocated to its own terminal to “0”, and transmits the bit value of the additional downlink traffic allocation request field to the BS 10.

Another example of a method for sending the additional downlink traffic allocation request from the MT 20 to the BS 10 at the above S130 can use a separate message for making or canceling the additional downlink traffic allocation request. In this case, the MT 20 generates an additional downlink traffic allocation request message or an additional downlink traffic allocation cancellation message that is separated from a dedicated uplink channel and sends the generated message to the BS 10.

Moreover, the MT 20 can send the additional downlink traffic allocation request message or the additional downlink traffic allocation cancellation message to the BS 10 using a piggybacking or a bandwidth stealing method. Here, piggybacking indicates a method for transmitting specific data using an available packet data space (e.g., remaining space) confirmed by a packet scheduler, and bandwidth stealing indicates a method for stealing part of a data transmission bandwidth to transmit the specific data. The piggybacking and the bandwidth stealing methods are well known in data transmission technology.

Of course, any methods for transmitting data between the MT 20 and the BS 10 can be employed so that the above step S130 can be performed.

The BS 10 receiving the additional downlink traffic allocation request is interworked with the scheduler and then determines whether or not additional resources can be allocated to the MT 20 (S135). Subsequently, when additional resources can be allocated to a corresponding MT 20, the BS 10 allocates the additional resources to the corresponding MT 20 (S140). Subsequently, in step S145, the BS 10 transmits a downlink signal through downlink traffic additionally allocated at the above step S140. For example, when the MT 20 makes an additional transmission bandwidth request, the BS 10 determines the transmission bandwidth occupancy states of the other MTs coupled thereto in a time zone when the MT 20 makes the additional transmission bandwidth request, and the BS 10 additionally allocates, to the MT 20, transmission bandwidth unoccupied by other MTs in the time zone.

Subsequently, the MT 20 buffers an additionally transmitted downlink signal (S150), and outputs a corresponding downlink signal at an output time of the buffered downlink signal (S155). For example, when the MT 20 simultaneously receives a plurality of image information units at a 5-ms interval, the MT 20 buffers the information indicating a time at which the plurality of image information units will be output together with the image information units, and selects and outputs image information to be reproduced at a desired time interval (e.g., 5-ms interval).

The MT 20 receives, in advance, a large amount of data from the BS 10 at a fast data transmission rate and buffers the received data. Moreover, the MT 20 uses the buffered data at a slow data transmission rate, such that the on-demand service can be seamlessly provided.

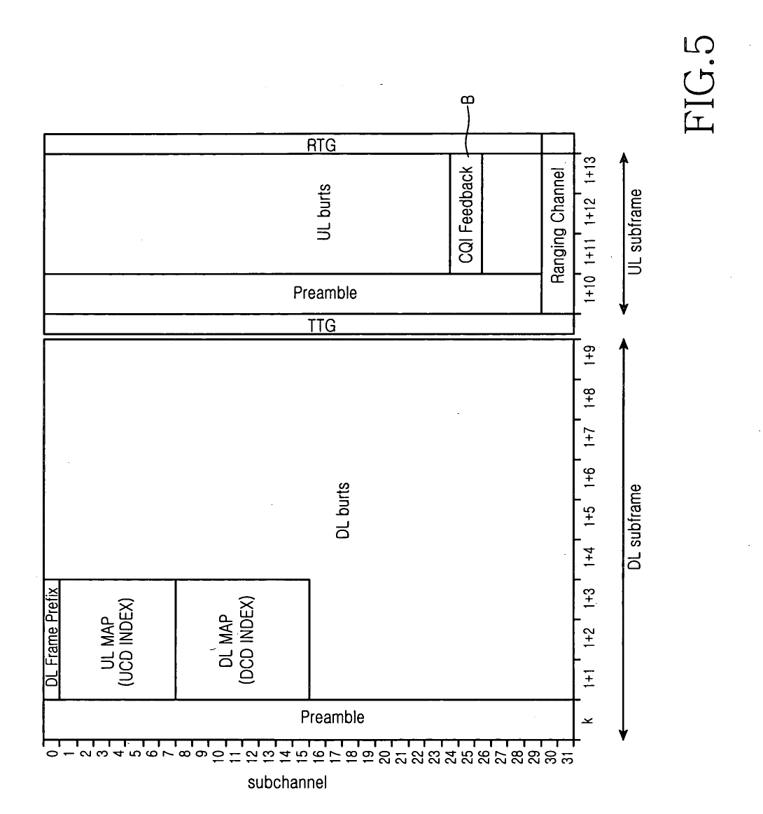

FIG. 5 shows the format of a conventional data frame in a broadband wireless access communication system based on the Orthogonal Frequency-Division Multiple-Access (OFDMA) technology. Referring to FIG. 5, a data frame of the conventional broadband wireless access communication system includes both uplink (UL) and downlink (DL) subframes. A transmit time gap (TTG) and a receive time gap (RTG) are included between the UL and DL subframes. In the example shown in FIG, 5, the DL subframe is located at the left side and the UL subframe is located at the right side. Data frames include a preamble, a UL map and a DL map, respectively. In particular, the frame includes a downlink channel descriptor (DCD) message after the DL map and an uplink channel descriptor (UCD) message after the UL map in the example of FIG. 5 so that the DCD and UCD messages can be transmitted.

The DL/UL map divides the DL/UL subframe into a plurality of sections, and allocates the position information of each section, a connection ID (CID) of each section and a downlink interval usage code (DIUC)/uplink interval usage code (UIUC). In this case, the CID indicates a destination subscriber terminal of the data transmitted by a corresponding section as a subscriber identification code. The DIUC/UIUC includes a purpose-related value, a modulation type value and a forward error correction (FEC) code value. The CID indicates the data purpose of a corresponding section, a modulation type and an FEC code.

In case of the broadband wireless access communication system having the data frame structure as described above, an additional downlink traffic allocation request bit is added to a channel quality information (CQI) feedback field “B” for transmitting the downlink signal quality information of each subscriber MT in the uplink subframe of the data frame. The MT is preferably implemented so that it can utilize the feedback field “B”.

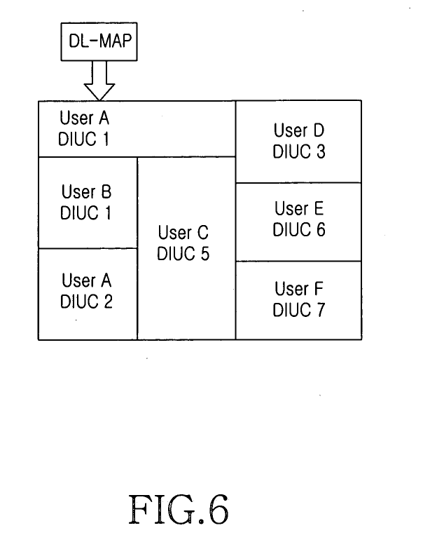

FIG. 6 illustrates a concept of allocating a downlink interval usage code (DIUC) to a user section-by-section in a downlink map (DL MAP) of a typical data frame in the broadband wireless access communication system. Referring to FIG. 6, the DL map divides the DL subframe into 7 sections. The 7 sections are allocated to users A to F. Each section is designed so that the data can be processed according to a modulation type and an encoding code mapped to one of the DIUCs 1 to 7. For example, the DL map is designed so that the data can be processed according to the modulation type and the encoding code mapped to the DIUC 1 in the section allocated to the user A and the data can be processed according to the modulation type and the encoding code mapped to the DIUC 7 in the section allocated to the user F.

Because the downlinks for the respective subscriber MTs do not simultaneously occur, an available interval is present.

Thus, the BS additionally allocates the downlink traffic to the MT making an additional downlink traffic allocation request in the available interval.

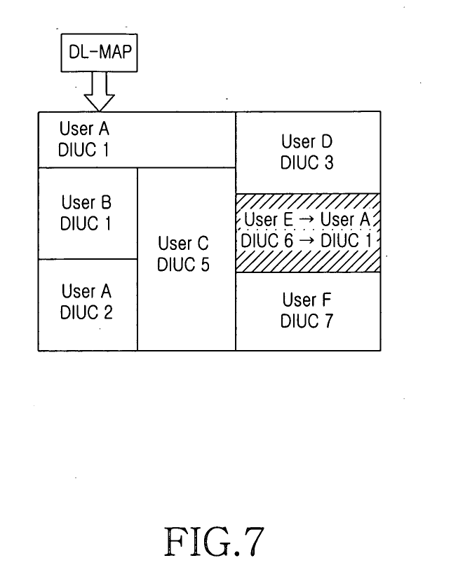

FIG. 7 shows the example of a data frame necessary for transmitting the result of a downlink traffic change from the BS to the MT in accordance with one embodiment of the present invention. That is, FIG. 7 shows an example in which the downlink traffic allocated to the user E is allocated to the user A when the user A sends an additional downlink traffic allocation request to the BS.

If the MT makes the additional downlink traffic allocation request at every frame interval using a specific bit added to an uplink subframe as shown in FIG. 4(b), the BS takes into account its resource state and allocates the downlink traffic based on only a corresponding frame.

When the MT makes the additional downlink traffic allocation request using a dedicated uplink channel or a separate message or using the piggybacking or the bandwidth stealing, the BS maintains the additional downlink traffic allocation before the next additional allocation request is received or a corresponding additional allocation is cancelled.

In order that an additional resource allocation request reaches the BS, is decoded and is reflected to the resource allocation, a time period corresponding to several frames is taken. When the BS recognizes the additional resource allocation request or the additional resource allocation cancellation, the BS determines whether or not to support additional resources, and performs a corresponding operation.

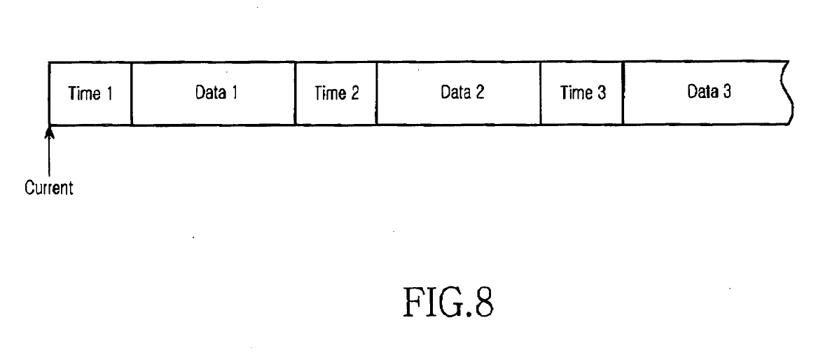

FIG. 8 shows an example of storing downlink data in a memory provided in the MT receiving added downlink traffic data in accordance with one embodiment of the present invention. The MT additionally receiving downlink data using the downlink traffic additionally allocated by the BS separates the received downlink data into a unitary data to be output at every preset unitary output time. The unitary data is buffered together with its output time information. FIG. 8 shows the example in which the downlink data is buffered. Referring to FIG. 8, Data 1 to be output at Time 1, Data 2 to be output at Time 2 and Data 3 to be output at Time 3 are buffered in the MT. The current time is present within a time range designated by Time 1. Thus, the MT outputs Data 1 at the current time.

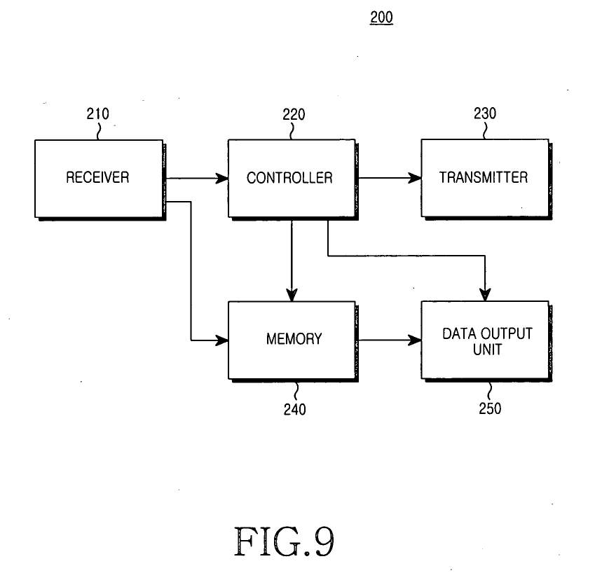

FIG. 9 is a block diagram illustrating the configuration of a mobile terminal (MT) 200 in accordance with one embodiment of the present invention. Referring to FIG. 9, the MT 200 in accordance with one embodiment of the present invention comprises a receiver 210, a controller 220, a transmitter 230, a memory 240 and a data output unit 250.

The controller 220 performs a control operation so that an additional downlink traffic allocation request can be sent to the BS if at least one predetermined requirement for an additional downlink traffic allocation request is met. For example, the controller 220 performs a control operation so that an additional downlink traffic allocation request can be sent to the BS if the quality of a downlink signal received from the BS is greater than a preset reference value and the MT 200 can additionally receive the downlink data using its internal resources. At this point, the MT's internal resources include a memory space capable of storing the downlink data.

A method for sending the additional downlink traffic allocation request to the BS under control of the controller 220 can be implemented using any well-known data transmission method. That is, the additional downlink traffic allocation request can be sent using various methods for sending data between the MT and the BS. An example of the additional downlink traffic allocation request method has been described above.

The transmitter 230 sends the additional downlink traffic allocation request to the BS under the control of the controller 220. For example, the transmitter 230 sends the additional downlink traffic allocation request, etc., to the BS.

The receiver 210 receives a downlink signal from the BS using the downlink traffic additionally allocated in response to the request.

The memory 240 separates the downlink signal received by the receiver 210 into the unitary data to be output at every preset unitary output time, and stores the unitary data together with its output time information. An example of a data storing method of the memory 240 has been described above with reference to FIG. 8.

The data output unit 250 outputs the unitary data on the basis of the output time information of the unitary data stored in the memory 240. The data output unit 250 includes a speaker for audibly outputting data and/or a display for visually outputting data. Thus, the data output unit 250 outputs the audible or visual data.

When data of the mobile communication network is sent, the present invention can enhance the service quality of a mobile communication network by taking into account the transmission quality based on a distance between the BS and the MT. That is, the data transmission efficiency of the mobile communication network can be enhanced. Therefore, when the data is transmitted between the BS and the MT, the remaining available resources can be maximally utilized. There is a merit in that the on-demand service in the mobile communication network can be stably provided. When the present invention is applied to the traffic transmission based on the best effort delivery service as a primary traffic form of the Internet, the BS can allocate resources for the MT within a short time period using the reaming resources of the BS in response to a resource request of the MT. For this reason, the efficiency of the frequency resource utilization can be increased, a resource demand from the MT can be quickly satisfied and the service can be effectively supported.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

1. A method for transmitting data in a mobile communication network, comprising the steps of:
determining, by the BS receiving an additional downlink traffic allocation request from a mobile terminal (MT), if the additional downlink traffic allocation is possible; and
if the additional downlink traffic allocation is determined to be possible, allocating the additional downlink traffic to the MT and transmitting a downlink signal using the downlink traffic including the additionally allocated downlink traffic from the BS.

2. The method of claim 1, further comprising the step of:
buffering, by the MT, the downlink signal received by the MT using the downlink traffic.

3. The method of claim 1 further comprising the steps of:
sending the additional downlink traffic allocation request from the MT to the BS, when at least one predetermined requirement is met.

4. The method of claim 3, wherein the determination by the MT of the at least one predetermined requirement, comprises the steps of:
measuring, by the MT receiving the downlink signal from the BS, a quality of the downlink signal;
comparing a measurement value based on the received downlink signal with a reference value of a preset downlink signal quality; and
determining that the at least one predetermined requirement is met when the measurement value is equal to or greater than the reference value.

5. The method of claim 3, wherein the determination by the MT of the at least one predetermined requirement, comprises the step of:
determining if the MT can receive additional downlink data using its internal resources,
wherein when the measurement value is equal to or greater than the reference value and the MT can receive additional downlink data using its internal resources, it is determined that the at least one predetermined requirement is met.

6. The method of claim 5, wherein the determining comprises the step of confirming a spare space of a memory inside the MT.

7. The method of claim 4, wherein the measuring step comprises the step of measuring at least one of a Signal to Noise Ratio (SNR), Carrier to Interference Ratio (CIR), a Signal to Interference and Noise Ratio (SINR), the average number of Cyclic Redundancy Checking (CRC) errors.

8. The method of claim 4, wherein the comparing step comprises the step of comparing the measurement value with the reference value of a preset downlink signal quality necessary for ensuring a basic normal data transmission in an application currently running in the MT.

9. The method of claim 3, wherein the sending step comprises the step of adding an additional downlink traffic allocation request bit to a preset field necessary for transmitting quality information of the downlink signal from the MT to the BS in an uplink subframe of a data frame, and using the additional downlink traffic allocation request bit.

10. The method of claim 3, wherein the sending step comprises the step of generating an additional downlink traffic allocation request message from the MT and transmitting the generated message to the BS.

11. The method of claim 10, further comprising the step of generating, by the MT, an additional downlink traffic allocation cancellation message to cancel the downlink traffic additionally allocated to the MT and transmitting the generated message to the BS.

12. The method of claim 3, wherein the sending step comprises the step of transmitting, by the MT, additional downlink traffic allocation information to the BS using a piggybacking method.

13. The method of claim 12, wherein the MT transmits the additional downlink traffic allocation cancellation information to the BS using the piggybacking method to cancel the additionally allocated downlink traffic.

14. The method of claim 3, wherein the sending comprises the step of transmitting additional downlink traffic allocation information from the MT to the BS using a bandwidth stealing method.

15. The method of claim 14, wherein the MT transmits the additional downlink traffic allocation cancellation information to the BS using the bandwidth stealing method to cancel the downlink traffic additionally allocated to the MT.

16. The method of claim 1, wherein the determining step further comprises the step of allocating additional downlink traffic to the MT based on a transmission bandwidth occupancy states of other MTs coupled to the BS.

17. A mobile terminal, comprising:
a controller for performing a control operation so that an additional downlink traffic allocation request can be transmitted to a base station (BS) when at least one requirement for the additional downlink traffic allocation request is met;
a transmitter for transmitting the additional downlink traffic allocation request to the BS under control of the controller; and
a receiver for receiving a downlink signal from the BS using a downlink traffic including additionally allocated downlink traffic in response to the request.

18. The mobile terminal of claim 17, further comprising a memory for separating the downlink signal received from the receiver into unitary data to be output at every preset unitary output time and storing the unitary data together with output time information of the unitary data.

19. The mobile terminal of claim 18, further comprising a data output unit for outputting the unitary data according to the output time information of the unitary data stored in the memory.

20. The mobile terminal of claim 17, wherein the controller performs a control operation so that the additional downlink traffic allocation request can be made when a measurement value based on the received downlink signal is equal to or greater than a reference value of a preset downlink signal quality and the MT can additionally receive downlink data using its internal resources.

21. The mobile terminal of claim 18, wherein the controller performs a control operation so that the additional downlink traffic allocation request can be made when a measurement value based on the received downlink signal is equal to or greater than a reference value of a preset downlink signal quality and the MT can additionally receive downlink data using its internal resources.

22. The mobile terminal of claim 19, wherein the controller performs a control operation so that the additional downlink traffic allocation request can be made when a measurement value based on the received downlink signal is equal to or greater than a reference value of a preset downlink signal quality and the MT can additionally receive downlink data using its internal resources.

23. The mobile terminal of claim 17, wherein the controller performs a control operation so that the additional downlink traffic allocation request can be made by adding an additional downlink traffic allocation request bit to a preset field necessary for transmitting a quality information of the downlink signal to the BS in an uplink subframe of a data frame, and using the additional downlink traffic allocation request bit.

24. The mobile terminal of claim 18, wherein the controller performs a control operation so that the additional downlink traffic allocation request can be made by adding an additional downlink traffic allocation request bit to a preset field necessary for transmitting a quality information of the downlink signal to the BS in an uplink subframe of a data frame, and using the additional downlink traffic allocation request bit.

25. The mobile terminal of claim 19, wherein the controller performs a control operation so that the additional downlink traffic allocation request can be made by adding an additional downlink traffic allocation request bit to a preset field necessary for transmitting a quality information of the downlink signal to the BS in an uplink subframe of a data frame, and using the additional downlink traffic allocation request bit.

26. The mobile terminal of claim 17, wherein the controller performs a control operation so that an additional downlink traffic allocation request message can be generated and the generated message can be transmitted to the BS.

27. The mobile terminal of claim 18, wherein the controller performs a control operation so that an additional downlink traffic allocation request message can be generated and the generated message can be transmitted to the BS.

28. The mobile terminal of claim 19, wherein the controller performs a control operation so that an additional downlink traffic allocation request message can be generated and the generated message can be transmitted to the BS.

29. The mobile terminal of claim 17, wherein the controller performs a control operation so that additional downlink traffic allocation information can be transmitted to the BS using a piggybacking method.

30. The mobile terminal of claim 18, wherein the controller performs a control operation so that additional downlink traffic allocation information can be transmitted to the BS using a piggybacking method.

31. The mobile terminal of claim 19, wherein the controller performs a control operation so that additional downlink traffic allocation information can be transmitted to the BS using a piggybacking method.

32. The mobile terminal of claim 17, wherein the controller performs a control operation so that additional downlink traffic allocation information can be transmitted to the BS using a bandwidth stealing method.

33. The mobile terminal of claim 18, wherein the controller performs a control operation so that additional downlink traffic allocation information can be transmitted to the BS using a bandwidth stealing method.

34. The mobile terminal of claim 19, wherein the controller performs a control operation so that additional downlink traffic allocation information can be transmitted to the BS using a bandwidth stealing method.

35. A mobile communication system, comprising:
a BS responsive to a request for allocating additional downlink traffic and transmitting a downlink signal using downlink traffic including the additionally allocated downlink traffic if additional downlink traffic allocation is determined to be possible.

36. The mobile communication system of claim 35, wherein the BS allocates the additional downlink traffic to a mobile terminal(MT) according to a transmission bandwidth occupancy states of other MTs coupled thereto.

37. The mobile communication system of claim 36, wherein the MT makes the additional downlink traffic allocation request when a measurement value based on the received downlink signal is equal to or greater than a reference value of a preset downlink signal quality and the MT can additionally receive downlink data using its internal resources.

38. The mobile communication system of claim 36, wherein the MT makes the additional downlink traffic allocation request by adding an additional downlink traffic allocation request bit to a preset field necessary for transmitting quality information of the downlink signal to the BS in an uplink subframe of a data frame and using the additional downlink traffic allocation request bit.

39. The mobile communication system of claim 36, wherein the MT makes the additional downlink traffic allocation request by generating an additional downlink traffic allocation request message and transmitting the generated message to the BS.

40. The mobile communication system of claim 36, wherein the MT makes the additional downlink traffic allocation request by transmitting additional downlink traffic allocation information to the BS using a piggybacking method.

41. The mobile communication system of claim 36, wherein the MT makes the additional downlink traffic allocation request by transmitting additional downlink traffic allocation information to the BS using a bandwidth stealing method.
